(19) United States
(12) Patent Application Publication
(10) Pub. No.: US 2017/0301958 A1
(43) Pub. Date: Oct. 19, 2017

(54) PLASMA DEPOSITION TO FABRICATE LITHIUM BATTERIES

(71) Applicants: Su Xiang DENG, Shanghai (CN); GM GLOBAL TECHNOLOGY OPERATIONS LLC, DETROIT, MI (US)

(72) Inventors: Su Xiang Deng, Shanghai (CN); Xiaohong Q. Gayden, West Bloomfield, MI (US)

(21) Appl. No.: 15/515,646

(22) PCT Filed: Oct. 3, 2014
(86) PCT No.: PCT/CN2014/088095

§ 371 Date: Mar. 30, 2017

(51) Int. Cl. H01M 10/0585; H01M 4/1391; H01M 4/04; H01M 10/0525; H01M 2/14

(52) U.S. Cl. CPC H01M 10/0585; H01M 10/0525; H01M 2/145; H01M 4/0404; H01M 4/1391

(57) ABSTRACT

Multi-layer lithium-ion cell units for lithium batteries are made using multiple stages of atmospheric plasma spray depositing devices. A suitable substrate layer is conveyed past the respective plasma spray devices to form, in a predetermined sequence, a current collector layer, a particulate electrode material layer, a porous separator layer for a liquid lithium-ion conducting electrolyte, a layer of particulate material for an opposing electrode, and a current collector film for the electrode material. The plasma deposition process allows flexibility and economy in making layered lithium-ion cell units. For example, the multistage process may be conducted in a continuous processing, multi-stage plasma deposition line in which one or more multi-layer cell units may be formed in the line.

### TECHNICAL FIELD

This invention pertains to the use of an atmospheric plasma deposition process to form, step-wise, each of the material layers of a cell for a lithium-ion battery. In an exemplary process, a layer of pouch-container resin-coated foil is used as a substrate for a sequence of plasma deposition steps in which a current collector layer is deposited on the substrate, followed by a porous layer of electrode material particles, a porous separator layer, a porous layer of opposing electrode material particles and a current collector layer.

### BACKGROUND OF THE INVENTION

Assemblies of lithium-ion battery cells are finding increasing applications in providing motive power in automotive vehicles. Each lithium-ion cell of the battery is capable of providing an electrical potential of about three to four volts and a direct electrical current, based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor, in a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

In these automotive applications, each lithium-ion cell typically comprises a negative electrode layer (anode, during cell discharge), a positive electrode layer (cathode, during cell discharge), a thin porous separator layer interposed in face-to-face contact between parallel, facing, electrode layers, and a liquid, lithium-containing, electrolyte solution filling the pores of the separator and contacting the facing surfaces of the electrode layers for transport of lithium ions during repeated cell discharging and re-charging cycles. Each electrode is prepared to contain a layer of an electrode material, typically deposited as a wet mixture on a thin layer of a metallic current collector.

For example, the negative electrode material has been formed by spreading a thin layer of graphite particles, or of lithium titanate particles, and a suitable polymeric binder onto one or both sides of a thin foil of copper which serves as the current collector for the negative electrode. The positive electrode also comprises a thin layer of resin-bonded, porous, particulate lithium-metal-oxide composition spread on and bonded to a thin foil of aluminum which serves as the current collector for the positive electrode. Thus, the respective electrodes have been made by dispersing mixtures of the respective binders and active particulate materials in a suitable liquid, depositing the wet mixture as a coating layer of controlled thickness on the surface of a current collector foil, and drying, pressing, and fixing the resin-bonded electrode particles to their respective current collector surfaces. The positive and negative electrodes may be formed on conductive metal current collector sheets of a suitable area and shape, and cut (if necessary), folded, rolled, or otherwise shaped for assembly into lithium-ion cell containers with suitable porous separators and a liquid electrolyte.

There is a need for improved practices by which cell members for lithium-ion are formed. There is a need for manufacturing processes by which the respective cell members can quickly and efficiently formed in a sequence of forming operations.

### SUMMARY OF THE INVENTION

In practices of this invention a series of atmospheric plasma spray devices are employed, as in a manufacturing line, to sequentially deposit suitably shaped layers of each electrode member, a current collector layer for each electrode layer, and a separator layer for a lithium-ion cell. In some embodiments of the invention, the cell members may be directly formed on suitable foil layer which serves as a container material, like a side of a pouch, for one side of the electrode assembly.

In general, each lithium-ion cell consists essentially of a porous separator member with opposing sides and a layer of porous particulate electrode material placed against the opposing sides. Thinner metal current collector layers are formed on the outer faces of the electrode layers. The respective cell material layers are often rectangular in shape and suitably co-extensive in area. The separator is shaped to assure that the facing electrode layers do not come into physical contact during cell operation. The electrode layers and the separator layer may, for example, be up to about two hundred microns in thickness. The metal current collector layers are typically thinner, e.g., up to about five to about twenty-five micrometers in thickness.

Atmospheric plasma generators and spray nozzles are commercially available and are adapted for formation of the layered lithium-ion cell unit structures using processes of this invention.

In an illustrative example of a practice of the invention, an organized sequence of supported plasma spray devices is used to deposit and form a five-layer cell structure, one layer at a time. For example, a grouping of resin-coated steel or aluminum foil members is used as non-conductive, non-reactive substrates on which successive cell layers are deposited by the arranged-in-line and separately controlled plasma spray devices. The coated metal foil substrates may, for example, be sized and shaped for use as a portion of a pouch, such as one side of a pouch, which is to be used to contain a fully assembled set of lithium-ion cell members including a non-aqueous liquid lithium-ion conducting electrolyte. An organized grouping of (e.g., rectangular) resin-coated metal foil substrates is placed on a suitable carrier belt which is supported, carried, and moved along a desired path by a programmed conveyor under a sequence of supported and downwardly directed atmospheric plasma spray stations at which different cell materials are sequentially applied. For example, at a first station of plasma spray devices, spanning the width of the conveyor belt, a thin coating of partially melted aluminum particles is applied as a cathode current collector layer on each of the arranged substrate foils. Each plasma spray device is directed to deliver partially melted aluminum particles in a predetermined pattern within the area of the upper face of the foil substrate and to provide an integral current collector of specified, uniform thickness. In some practices of the process, an aluminum connector tab may be pre-placed on the substrate for incorporation into the deposited cathode current collector layer. The substrates are then moved on the conveyor belt and located under a second group of plasma spray devices that coat each of the aluminum layers with a complementary pattern of bonded particles of cathode material in a porous layer of the cathode material.

In a progressive sequence of plasma deposition steps, at locations further along the path of the conveyor belt, a bonded porous layer of separator particles are applied to each cathode particle layer, a porous layer of inter-bonded anode material particles are bonded to the upper face of each separator layer, and a layer of copper particles is deposited as a non-porous current collector layer on the upper face of each anode material layer. Depending on the chemistry of the electrode materials, and their bonding characteristics when activated in the plasma, it may be desirable to provide a separate source of a particulate or semi-liquid binder material as the particulate electrode materials are delivered in their plasma stream onto the surface of a previously formed layer of cell material.

In general this atmospheric plasma spray processing may be practiced in an ambient indoor environment maintained at a suitable room temperature.

The groupings of five-layer cell unit structures are removed from their respective substrate carriers and are ready for examination, approval, and further assembly into lithium-ion cells or modules of cells. Some cell members may be adapted for cell voltage or other cell operating properties. The assembly of the layered cells may include the use of the resin-coated metal substrate layer when it is composed and shaped as side of a pouch-container for the confinement of the cell members and their liquid lithium-ion containing electrolyte.

By way of example, suitable positive electrode (cathode) materials include lithium manganese nickel cobalt oxide (NMC), lithium manganese oxide (LMO), lithium cobalt oxide (LCO), lithium nickel cobalt aluminum oxide (NCA), lithium iron phosphate (LFP), and other lithium-complementary metal(s) oxides or phosphates. And examples of suitable negative electrode (anode) materials include lithium titanate (LTO), graphite, and silicon-based materials such as silicon, silicon alloys, SiOx, and LiSi alloys.

Suitably porous separators, for non-aqueous liquid, lithium-ion conducting electrolytes, have been made of particles of polymers such as polyethylene, polypropylene and ethylene-propylene copolymers. Particles of these polymers may be deposited using suitably low-energy plasmas or by non-plasma spray devices. Separators may also be formed using ceramic particles such as metal oxides and metal phosphates. The metal compounds may, optionally, include lithium. The ceramic particles may be co-deposited, if desired, with a suitable polymeric binder material from the some plasma device or a complementary plasma or spray device.

Other objects and advantages of this invention will be apparent from a further detailed description of the methods and compositions, which follows in this specification.

### BRIEF DESCRIPTION OF THE DRAWINGS

FIG. 1 is a schematic illustration of a plasma deposition apparatus being used to deposit particulate electrode material on a previously deposited current collector layer. This figure illustrates, for example, the second plasma deposition step in the five-step process depicted in FIG. 2

FIG. 2 is a schematic illustration of a five-step plasma deposition apparatus comprising a supported and driven conveyor belt carrying arranged groupings of substrate foils under and past five groupings of conveyor nozzles for the making of five-layer lithium-ion cell units.

### DESCRIPTION OF PREFERRED EMBODIMENTS

In practices of this invention, methods are provided using atmospheric plasma generators and spray directing nozzles for forming flat-type layered cell units for lithium batteries. The methods have particular application to the formation of cell units for lithium-ion batteries and they advantageously enable the formation of the solid members of the cell in an efficient production line, using an organized arrangement of atmospheric spray devices to make a wide range of cell member compositions and shapes. Generally, in this flexible method utilizing a conveyor line and suitably placed and programmed plasma spray devices, it is preferred to first deposit a current collector layer on an inert substrate and to sequentially apply the corresponding electrode layer, a solid electrolyte layer, an opposing electrode layer and its current collector layer to form the five-layer cell unit. The first and subsequent layers are deposited on a suitably coated and shaped metal foil surface which may also serve as one portion of a pouch-container for a lithium-ion cell or group of cells.

As stated above, and by way of examples, suitable positive electrode (cathode) materials include lithium manganese nickel cobalt oxide (NMC), lithium manganese oxide (LMO), lithium cobalt oxide (LCO), lithium nickel cobalt aluminum oxide (NCA), lithium iron phosphate (LFP), and other lithium metal oxides or phosphates. And examples of suitable negative electrode (anode) materials include lithium titanate (LTO), graphite (such as mesocarbon microbeads, MCMB), and silicon-based materials such as silicon, silicon alloys, SiOx, and LiSi alloys.

The separator material is selected to be deposited in accordance with practices of this invention as a porous layer that is later infiltrated with a liquid electrolyte. The separator serves as an electrical insulator between the electrode members formed and lying against its opposing sides. In many embodiments a polymer such as polyethylene oxide (PEO) or polyvinylidene difluoride (PVDF) is selected to be co-deposited (in the same or separate plasma injectors) with a ceramic material such as alumina (Al₂O₃), silica (SiO₇), or magnesium oxide (MgO).

Optionally the Ceramic Material may Comprise Lithium Containing Glass Materials such as:
1. Oxide glass: Li₂O-P₂O₅-B₂O₃, g-Li₃PO₄, Li₂O-Li₂SO₄-B₂O₃, Li₄GeO₄/Li₃VO₄
2. Sulfide and oxysulfide glass: Li₃PO₄-Li₂S-SiS₂, Li₂S-SiS₂-Li₄SiO₄, SiS₂-P₂S₅-Li₂S-LiI
3. LIPON (Lithium phosphorous oxynitride): xLi₂O:yP₂O₅:zPON, where x ranges from about 2.8 to 3.8, y ranges from about 3.2 to 3.9, and z ranges from about 0.2 to 0.9.
   Lithium-containing Ceramics for the Separators may also Comprise Materials such as:
1. Lithium perovskites: LiₓLa_{2/3-x/3 1/3-2x/3}TiO₃
2. Garnet-type: Li₇₋ₓLa₃Zr₂O_{12-0.5x}(LLZO)
3. NASICON type glass-ceramic: Li₁₊ₓMₓTi₂₋ₓ(PO₄)₃ (M=Al, In)
4. LISICON type glass-ceramic: Li₂₊₂ₓZn₁₋ₓGeO₄

The separator is formed to he infiltrated with a suitable electrolyte for the lithium-ion cell. The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (Li ClO₄), lithium exafluoroarsen ate (Li AsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and liquid solvent is selected for providing suitable mobility and transport of lithium ions in the operation of the cell. The electrolyte is carefully dispersed into and between closely spaced layers of the electrode elements and separator layers.

Atmospheric plasma generators and application nozzles for the methods of the present application are commercially available and may be carried and used on suitably supported robot arms, under computer-controlled multi-directional movement, to coat surfaces of an organized pattern of planar substrates which are conveyed under the plasma nozzles. Successive layers of lithium-ion cell material are applied to the substrates. Multiple nozzles may be required and arranged in such a way that a desired coating speed may be achieved in terms coated area per unit of time.

The plasma nozzle typically has a metallic tubular housing which provides a flow path of suitable length for receiving the flow of a working gas carrying dispersed particles of lithium-ion cell material, and for enabling the formation of the plasma stream in an electromagnetic field established within the flow path of the tubular housing. The tubular housing typically terminates in a conically tapered outlet, shaped to direct the contained, particle-carrying, plasma stream toward an intended substrate to he coated. An electrically insulating ceramic tube is typically inserted at the inlet of the tubular housing, such that it extends along a portion of the flow passage. A stream of a working gas, such as air, and carrying dispersed particles of lithium-cell component material, is introduced into the inlet of the nozzle. The flow of the air-particle Mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a high frequency generator at a frequency of about 50 to 60 kHz (for example) and to a suitable potential of a few kilovolts. The metallic housing of the plasma nozzle is grounded. Thus, an electrical discharge can be generated between the axial pin electrode and the housing.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/particulate electrode material stream to the outlet of the nozzle. A reactive plasma of the air (or other carrier gas) and suspended particulate lithium-cell material mixture is formed at a relatively low temperature. A copper nozzle at the outlet of the plasma container is shaped to direct the particle-carrying plasma stream in a suitably confined path against the surfaces of the substrates for the lithium-ion cell elements. And the plasma nozzle may be carried by a computer-controlled robot to move the plasma stream in multi-directional paths over the planar surface of the substrate material to deposit the electrode material in a continuous thin layer on the thin substrate surface layer. The deposited plasma-activated material forms an adherent porous layer of bonded lithium-cell material particles on the current collector foil surface.

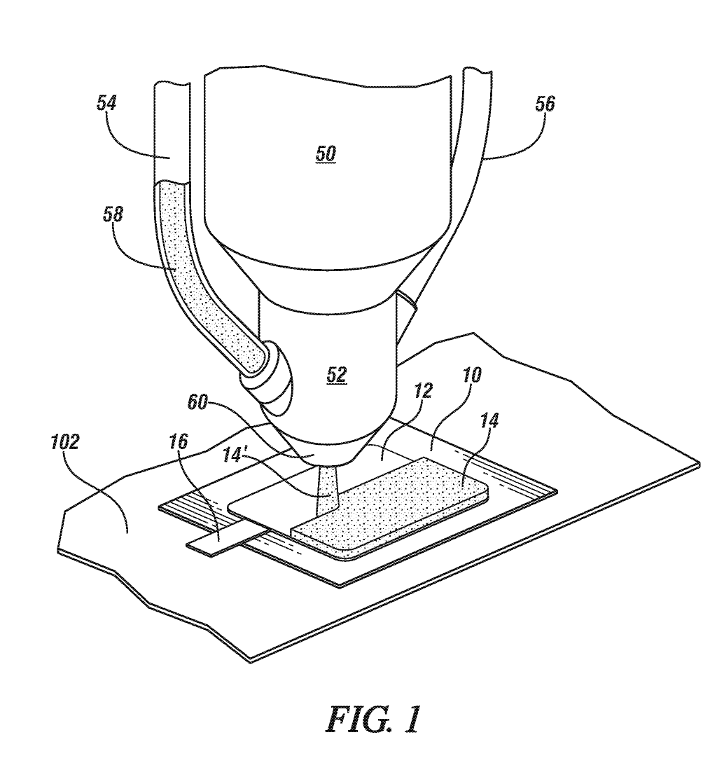

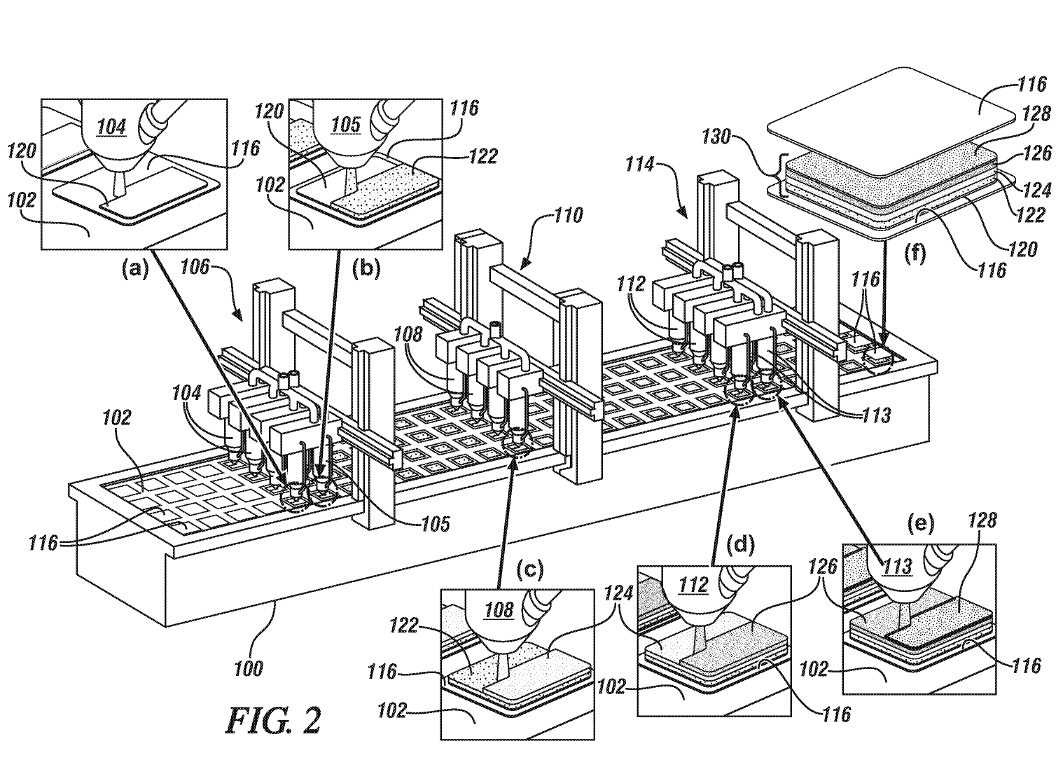

FIG. 1 illustrates the practice of depositing particles of an electrode material, for example a particulate cathode material, onto a previously deposited layer 12 of aluminum which is to serve as the current collector for the cathode material. In FIG. 1, a layer 14 of particulate cathode material is being deposited from an atmospheric plasma stream onto a previously deposited aluminum current collector layer 12. Connector tab 16 on current collector layer 12 may be formed integrally with the current collector layer 12. The current collector layer 12 was previously deposited on a larger substrate material 10. Tab 16 was placed on substrate 10 and the current collector material 12 deposited over and around it to form an integral current collector 12 and connector tab 16 layer. As described further in this specification, substrate 10 may be, simply, a non-sticky, non-reactive material to receive sequentially deposited lithium-ion cell material. Or substrate 10 may serve some an additional function such as a non-conductive portion of a container for the formed cell materials. Substrate material 10 is supported on a suitable base or carrier, which may, for example be a conveyor belt 102 as described further in FIG. 2.

The current collector layer 12 and active cathode material layer 14 are preferably in the predetermined intended shape and size of the elements of a specified lithium-ion cell. In this example, the aluminum current collector member 12 and cathode material layer 14 are illustrated in the form of a thin, square plate of about 100 millimeters length on each side, but the cell elements are also often made in other rectangular shapes and dimensions depending on the intended size of the cell elements and assembled cell modules. The cathode material layer 14 may, for example, may be up to about one hundred micrometers in thickness. The cathode current collector layer is often about ten to twelve micrometers in thickness. The substrate 10 is placed in a flat position at ambient conditions under a suitable atmospheric plasma spray generator and nozzle for sequential deposition of the layers of lithium-ion cell material.

In practices of this invention, and with reference to FIG. 1 an atmospheric plasma apparatus may comprise an upstream round flow chamber (shown in partly broken-off illustration at 50 in FIG. 1) for the introduction and conduct of a flowing stream of suitable working gas, such as air, nitrogen, or an inert gas such as helium or argon. The flow of the working gas would be introduced above the broken-off illustration of flow chamber 50 and proceed in a downward direction. In this embodiment, this illustrative initial flow chamber 50 is tapered inwardly to smaller round flow chamber 52. Particles of electrode material composition for the specified lithium-ion cell (in this example, active cathode material) 58 are delivered through supply tubes 54, 56 (tube 54 is shown partially broken-away to illustrate delivery of the active electrode material particles 58) and are suitably introduced into the working gas stream in chamber 52 and then carried into a plasma nozzle 60 in which the air (or other working gas) is converted to a plasma stream at atmospheric pressure. And, for example, particles of active cathode material composition may be delivered through supply tubes 54 and 56. As the active electrode material particles 58 enter the gas stream in chamber 52 they are dispersed and mixed in the stream and carried by it. As the stream flows through the downstream plasma-generator nozzle 60, the particles 58 are heated by the formed plasma to a precursor processing temperature and an active material particle deposition temperature. The momentary thermal impact on the particles may be a temperature of from about 300° C. up to about 3500° C.

In this example, the stream of air-based plasma and suspended, plasma-activated, cathode particle material 14′ is progressively directed by the nozzle 60 to deposit cathode material 14 against the exposed upper surface of current collector member 12. The nozzle 60 and stream of suspended cathode material 14′ is moved in a suitable path and at a suitable rate such that the particulate cathode material 14′ is deposited as a layer of lithium-ion cell cathode material 14 of specified thickness on the surface of the current collector member 12. The cathode material 14 is not deposited on tab 16 of current collector 12. The plasma apparatus, including chamber 50, nozzle 60, etc., may be carried on a robot arm (not illustrated in FIG. 1) and the control of plasma generation and the movement of the robot arm be managed under control of a programmed computer. In some practices of the invention, substrate 10 may be carried, for example, on a conveyor belt (like conveyor belt 102 in FIG. 2) and positioned under plasma spray nozzle 60. Spray nozzle 60 may be moved to direct its stream of cathode material particles 14′ to suitably form cathode material layer 14 coextensive with and overlying the aluminum current collector layer 12. When the formation of the cathode material layer is completed, the substrate 10 with its current collector layer 12 and cathode material layer 14 may be moved to a further plasma processing location.

In some embodiments of the invention it may be preferred or necessary to separately spray or otherwise apply particles or droplets of a binder material to assist in bonding particles of electrode material or separator material to each other and to an underlying layer.

In practices of this invention, a five-layer lithium ion cell structure is formed in a sequence of atmospheric plasma deposition steps. This sequence of coating operations will be described with reference to the schematic illustration of FIG. 2 of this specification.

Referring to FIG. 2, a motorized and computer-controlled conveyor system 100 is employed in the making of five-layer lithium-ion cell units. Conveyer system 100 may be located in the ambient environment of a suitable manufacturing facility. Conveyor system 100 has a driven belt 102 which is driven from left to right in FIG. 2. Viewing from left-to-right, a first plasma coating stage of four sets (arranged cross-wise to the length and to the direction of the movement of conveyor belt 102) of two in-line plasma delivery nozzles 104. 105 (each nozzle in the first cross-wise line, 104 and each nozzle in the second cross-wise line 105) are supported on an upright structure 106. As will be described in more detail, the first cross-wise stage of the in-line plasma nozzles 104 (from left to right) are supplied and managed to deliver four, side-by-side, streams of plasma-activated aluminum particles and the second set of four in-line plasma nozzles 105 are supplied and managed to deliver four side-by-side streams of plasma-activated cathode material. Next is a second cross-wise plasma coating stage of four plasma nozzles 108, supported on upright structure 110. This set of four plasma nozzles 108 are supplied and managed to deliver four side-by-side streams of separator material for the specified lithium-ion cell. A third plasma coating stage comprises four cross-wise sets of two in-line plasma nozzles 112, 113 supported on upright structure 114. In this grouping of two in-line inline plasma nozzles 112, 113 the first set of four cross-wise plasma nozzles 112 are supplied and managed to deliver four side-by-side streams of plasma-activated anode material, and the second set of four cross-wise plasma nozzles 113 are supplied and managed to deliver four side-by-side streams of plasma-activated copper particles for a current collector for the anode material.

At the left end of the conveyor system 100, four rows of resin coated steel or aluminum substrate foils 116 are continually and timely placed on conveyor belt 102, with each length-wise and cross-wise row (with respect to conveyor belt movement) of the substrate foils 116 being in line with a succession of in-line plasma jets. The metal substrates are resin coated so as to support the successive layers of plasma deposited cell material and to prevent the deposited cell material from bonding to them. In this illustrative embodiment of ⁻the invention, the resin-coated substrate foils 116 are sized and shaped to also serve as a portion (e.g., one side) of an electrically insulated pouch container for the five layers of cell members produced in this line of plasma nozzles and a later-inserted liquid electrolyte for the cell.

Suitable controls are provided for operation of the conveyor belt and the respective plasma nozzles so as to coordinate timely deposition of the cell material where it is intended to be deposited. Each cross-wise row of substrates 116 may be momentarily stopped at each suitably-spaced plasma delivery location and the plasma nozzles are movable on their supports so as to provide coated material layers of a predetermined shape, area, and thickness.

In the first plasma coating stage (the left set of the two in-line plasma nozzles 104), particles of aluminum are simultaneously deposited on four substrates 116 as a cathode current collector film. Each nozzle is moved so as to deposit a predetermined pattern of current collector film 120 as a first layer, see insert (a), on the cross-wise row of four substrates 116. The deposited pattern of aluminum 120 may include an electrical connector tab (not illustrated in FIG. 2, but illustrated as tab 16 on current collector 12 in FIG. 1). The cross-wise row of substrates is then advanced to the second set of in-line plasma delivery nozzles 105. This set of plasma nozzles 105 is managed and controlled to apply a uniform coating of particulate cathode material 122 (see insert (b) in FIG. 2) overlying the current collector films 120 on the four substrates 116.

As the conveyor belt is progressively and intermittently advanced, a layer of porous separator material 124 is deposited coextensively with the cathode material layer 122, insert in the next stage of the conveyor process, plasma-activated anode particles 126 are deposited in a coextensive porous anode layer over the separator layer 124, insert (d). And in a final plasma deposition stage, plasma-activated copper particles are deposited as a current collector layer 128 overlying the anode layer 126, insert (e). Provision may be made (not illustrated) for placement of suitably shaped tabs on each anode material layer 126 so that the deposited anode current collector material incorporates the tab, for example, like cathode current collector tab 16 in FIG. 1.

The five-layer lithium-ion cell units 130 are removed from the conveyor belt at the right end of the conveyor system. Each unit is formed of a central porous separator layer 124 with a layer of cathode material 122 and overlying aluminum cathode current collector layer 120 on one side of the electrolyte layer 124, and a layer of anode material 126 and an overlying layer of copper current collector 128 on the other side of the solid electrolyte layer 124. Further, original substrate layer 116 may be retained as a pouch-container layer on the bottom side (as illustrated in insert (f) of FIG. 2) of the five-layer lithium-ion cell unit 130. As further illustrated in insert (f), a second resin-coated metal foil layer 116 may be placed on the other side of the five-layer lithium-ion cell unit 130.

The thus-formed cell unit 130 is removed from the conveyor system in which it was formed and is ready for any desired inspection, packaging in a pouch-container or the like, insertion of liquid electrolyte, container closure, electrical connection with other cell units, and any other desired manufacturing and assembly operations.

Thus, atmospheric plasma application methods have been disclosed for the formation of lithium cells, with layered cell members, using a conveyor line and multiple atmospheric plasma applications stages in which cell member materials are sequentially deposited on an initial substrate. But the scope of methods and compositions of the lithium-ion cell layers and plasma deposition steps are not limited to the specific examples.

1. A method of making a five-layer lithium-ion cell unit for a lithium battery, the lithium-ion cell unit comprising a cathode current collector layer, a layer of cathode material particles, a porous separator layer, a layer of anode material particles, and an anode current collector layer; the method comprising:
activating particles of metal current collector composition in an atmospheric plasma device and depositing a stream of the current collector particles onto a substrate surface that is electrically non-conductive and non-reactive with the deposited current collector particles, the current collector particles being deposited as a layer of predetermined thickness and flat two-dimensional shape;
activating particles of first electrode material, cathode or anode and compatible with the deposited current collector layer, in an atmospheric plasma device and depositing a stream of the electrode material particles as a porous first electrode layer, the first electrode material layer being deposited on the metal current collector layer as a first electrode layer of predetermined thickness and flat two-dimensional shape;
depositing particles of a separator material as a porous separator layer onto the surface of the first electrode material layer, the separator layer being deposited as a layer of predetermined thickness and flat two dimensional shape;
activating particles of the opposing electrode material, anode or cathode, in an atmospheric plasma device and depositing a stream of the activated opposing electrode material particles as a porous opposing electrode layer on the porous separator layer, the opposing electrode material being deposited on the separator layer as an electrode layer of predetermined thickness and flat two-dimensional shape; and
activating particles of metal current collector composition in an atmospheric plasma device and depositing a stream of the current collector particles as a current collector layer onto the opposing electrode layer, the current collector particles being deposited as a current collector layer of predetermined thickness and flat two dimensional shape.

2. A method of making a lithium-ion cell unit for a lithium battery as stated in claim I in which a bonding resin is separately applied with the deposited particles of electrode materials as they are deposited to bond the electrode particles to each other and to the material on which they are deposited.

3. A method of making a lithium-ion cell unit for a lithium battery as stated in claim 1 in which the cathode material comprises one or more of lithium manganese nickel cobalt oxide (NMC), lithium manganese oxide (LMO), lithium cobalt oxide (LCO), lithium nickel cobalt aluminum oxide (NCA), lithium iron phosphate (LFP), and other lithium metal oxides or lithium metal phosphates.

4. A method of making a lithium-ion cell unit for a lithium battery as stated in claim 1 in which the anode material comprises one or more of lithium titanate (LTO), graphite, and silicon-based materials such as silicon, silicon alloys, SiOx, and LiSi alloys.

5. A method of making a lithium-ion cell unit for a lithium battery as stated in claim 1 in which the substrate is a resin-coated metal foil that is shaped and sized to serve as a side of a pouch-container for the lithium ion cell members.

6. A method of making a lithium-ion cell unit for a lithium battery as stated in claim 1 in which each layer of the five-layer lithium-ion cell is formed using a succession of atmospheric plasma application devices in a processing line.

7. A method of making a lithium-ion cell unit for a lithium battery as stated in claim 1 in which each layer of the five-layer lithium-ion cell is formed by using a succession of atmospheric plasma application devices in a processing line without removing a partially-formed, layered lithium-ion cell member from the processing line.

8. A method of making a lithium-ion cell unit for a lithium battery as stated in claim 1 in which a plurality of substrates are placed side-by-side across the width of a conveyor belt which as progressively advanced past a succession of the same number of atmospheric plasma devices to simultaneously form a plurality of five layer-lithium-ion cell units.

9. A method of making a lithium-ion cell unit for a lithium battery as stated in claim 7 in which the substrate is a resin-coated metal foil that is shaped and sized to serve as a side of a pouch-container for the lithium ion cell members.

10. A method of making a lithium-ion cell unit for a lithium battery, the lithium-ion cell unit comprising a layer of a lithium-ion containing separator material with two opposing faces, a layer of particulate anode material bonded to one of the faces of the separator layer and a layer of particulate cathode material bonded to the opposing face of the separator layer; the method comprising:
activating particles of a first electrode material, an anode or cathode material, for the lithium-ion cell in an atmospheric plasma and directing the stream of particles of the electrode material against a flat surface of a metal foil so as to form a self-sustaining layer of electrode material in a predetermined area and of predetermined uniform thickness;
activating particles of an lithium-ion containing separator material for the lithium-ion cell in an atmospheric plasma and directing the stream of particles of the separator material against the layer of applied electrode material to form a self-sustaining porous layer of the separator material that is co-extensive with the electrode layer; and
activating particles of the opposing electrode material, cathode or anode, for the lithium-ion cell in an atmospheric plasma and directing the stream of particles of the electrode material against the applied layer of separator material to form a self-sustaining layer of the electrode material that is co-extensive with the separator layer

11. A method of making a lithium-ion cell unit for a lithium battery as stated in claim 10 in which the separator layer is formed by activating particles of a plasma-temperature resistant lithium-ion containing separator material in an atmospheric plasma stream and depositing them on a preformed plasma deposited layer of an electrode material for a lithium-ion cell.

12. A method of making a lithium-ion cell unit for a lithium battery as stated in claim 10 in which the cathode material comprises one or more of lithium manganese nickel cobalt oxide (NMC), lithium manganese oxide (LIMO), lithium cobalt oxide (LCO), lithium nickel cobalt aluminum oxide (NCA), lithium iron phosphate (LFP), and other lithium metal oxides.

13. A method of making a lithium-ion cell unit for a lithium battery as stated in claim 10 in which the anode material comprises one or more of lithium titanate (LTO), graphite, and silicon-based materials such as silicon, silicon alloys, SiOx, and LiSi alloys.

14. A method of making a lithium-ion cell unit for a lithium battery as stated in claim 10 in which the metal foil is shaped and sized and of a composition to serve as a current collector for the first electrode material.

15. A method of making a lithium-ion cell unit for a lithium battery as stated in claim 10 in which the metal foil is a resin-coated metal foil that is shaped and sized to serve as a side of a pouch container for the lithium-ion cell members.

16. A method of making a lithium ion cell for a lithium battery as stated in claim 10 in which each layer of the lithium-ion cell is formed using a succession of atmospheric plasma application devices in a processing line.

17. A method of making a lithium ion cell for a lithium battery as stated in claim 10 in which each layer of the lithium-ion cell is formed by using a succession of atmospheric plasma application devices in a processing line without removing a partially formed layered lithium-ion cell member from the processing line.
